(19) United States
(12) Patent Application Publication
(10) Pub. No.: US 2010/0073727 A1
(43) Pub. Date: Mar. 25, 2010

(54) SYSTEM AND METHOD FOR GREETING CARD TEMPLATE MATCHING

(76) Inventor: Marianne L. KODIMER, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/233,907

(22) Filed: Sep. 19, 2008

(51) Int. Cl. G06K 15/00; G09G 5/00

(52) U.S. Cl. 358/1.18; 345/630; 382/165; 382/218

(57) ABSTRACT

The subject application is directed to a system and method for greeting card template matching. Color image data is received from an associated user. A plurality of greeting card templates are stored, with each template having associated color data corresponding to its colorization. Colorization properties of received color image data are isolated and tested relative to the color data corresponding to each of the templates. A subset of the templates is identified according to the output of the testing and a display is generated including indicia corresponding to each of the subset of templates. Template selection data corresponding to at least one greeting card template selected from the subset is received, and a greeting card image is generated inclusive of a rendering of the received color image data and the greeting card template

### BACKGROUND OF THE INVENTION

The subject application is directed generally to generation of custom greeting cards. The application is particularly suited for generation of customized greeting cards inclusive of user-supplied images, such as photographs, into a greeting card template with a color scheme visually compatible with properties of the supplied image.

Traditionally, greeting cards were created by specialized manufacturers who designed various themes for various recipients and occasions. Given the many varieties of situations for which greeting cards are used, it was incumbent on the suppliers and retailers to dedicate a large display area for users to peruse and select their greeting card purchases. Given the cost of retail space, along with assisting users in their selection by eliminating out-of-season greeting card options, it is incumbent on the retailer to constantly update and refresh their display areas.

More recently, with the advent of document printing devices that are relatively inexpensive, easy to operate, and provide high quality, an alternative to traditional greeting card sales has arisen. Customized greeting card generators, such as point-of-sale computing devices with associated printers, have become popular. One embodiment is provided with a greeting card kiosk, which allows users to select a theme, customize content, and printout a customized greeting card. Such systems provide many advantages relative to storing multiple user options with minimal or efficient modification of options and a minimization of required retail floor space.

More recently, the advent of digital cameras and access to networked content has given users access to more customized images.

### SUMMARY OF THE INVENTION

In accordance with one embodiment of the subject application, there is provided a system and method for greeting card template matching. Color image data is received from an associated user. A plurality of greeting card templates are stored, wherein each greeting card template having associated color data corresponding to a colorization thereof. Colorization properties of received color image data are isolated and tested relative to color data corresponding to each of the plurality of greeting card templates. A subset of plurality of greeting card templates are identified in accordance with an output of the testing and a display is generated including indicia corresponding to each of the subset of greeting card templates. Template selection data corresponding to at least one greeting card template selected from the subset thereof is received and a greeting card image is generated inclusive of a rendering of the received color image data and at least one greeting card template.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a greeting card template matching system according to one embodiment of the subject application;

FIG. 2A is a view representing a tangible output media storage tray for use in the greeting card template matching system according to one embodiment of the subject application;

FIG. 2B is a view representing a single tangible output media for use in the greeting card template matching system according to one embodiment of the subject application;

FIG. 3 is a block diagram illustrating device hardware for use in the greeting card template matching system according to one embodiment of the subject application;

FIG. 4 is a functional diagram illustrating the device for use in the greeting card template matching system according to one embodiment of the subject application;

FIG. 5 is a block diagram illustrating controller hardware for use in the greeting card template matching system according to one embodiment of the subject application;

FIG. 6 is a functional diagram illustrating the controller for use in the greeting card template matching system according to one embodiment of the subject application;

FIG. 7 is a block diagram illustrating the greeting card template matching system according to one embodiment of the subject application;

FIG. 8 is a functional block diagram illustrating the greeting card template matching system according to one embodiment of the subject application;

FIG. 9 is a flowchart illustrating a method for greeting card template matching according to one embodiment of the subject application;

FIG. 10 is a flowchart illustrating a method for greeting card template matching according to one embodiment of the subject application;

FIG. 11 is a screen shot illustrating an example implementation of the system and method for greeting card template matching according to one embodiment of the subject application;

FIG. 12 is a screen shot illustrating an example implementation of the system and method for greeting card template matching according to one embodiment of the subject application;

FIG. 13 is a screen shot illustrating an example implementation of the system and method for greeting card template matching according to one embodiment of the subject application; and

FIG. 14 is a screen shot illustrating an example implementation of the system and method for greeting card template matching according to one embodiment of the subject application.

### DETAILED DESCRIPTION OF THE PREFERRED EMBODIMENT

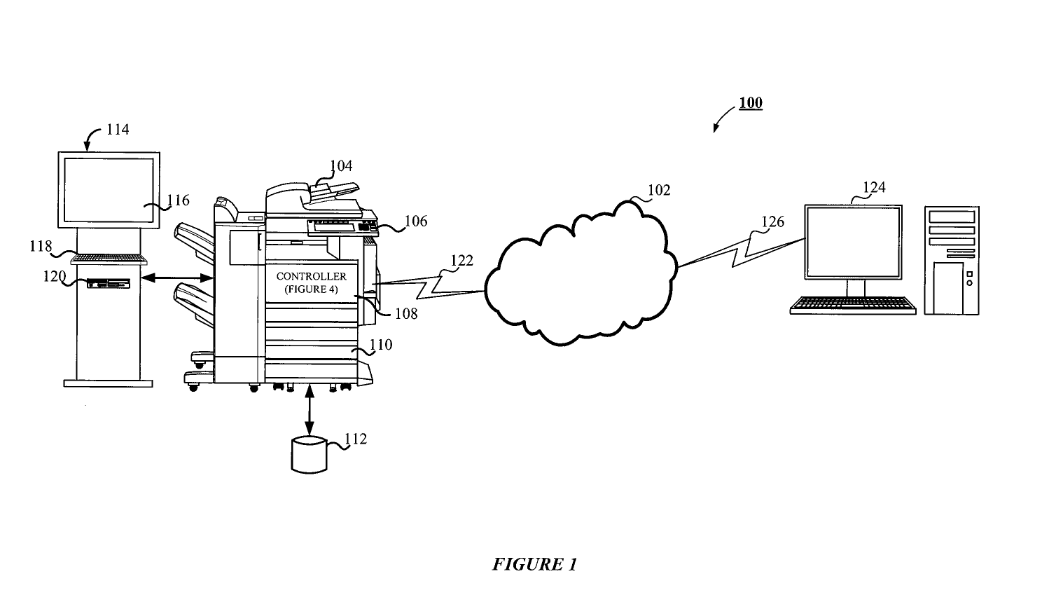

The subject application is directed to a system and method for greeting card template matching. In particular, the subject application is directed to a system and method for generation of customized greeting cards inclusive of user-supplied images, such as photographs, into a greeting card template with a color scheme visually compatible with properties of the supplied image. It will become apparent to those skilled in the art that the system and method described herein are suitably adapted to a plurality of varying electronic fields employing user supplied images, including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for greeting card template matching in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document rendering device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the document rendering device 104 is suitably adapted to provide remote document processing services to external or network devices. Preferably, the document rendering device 104 includes hardware, software, and any suitable combination thereof, configured to interact with an associated user, a networked device, or the like.

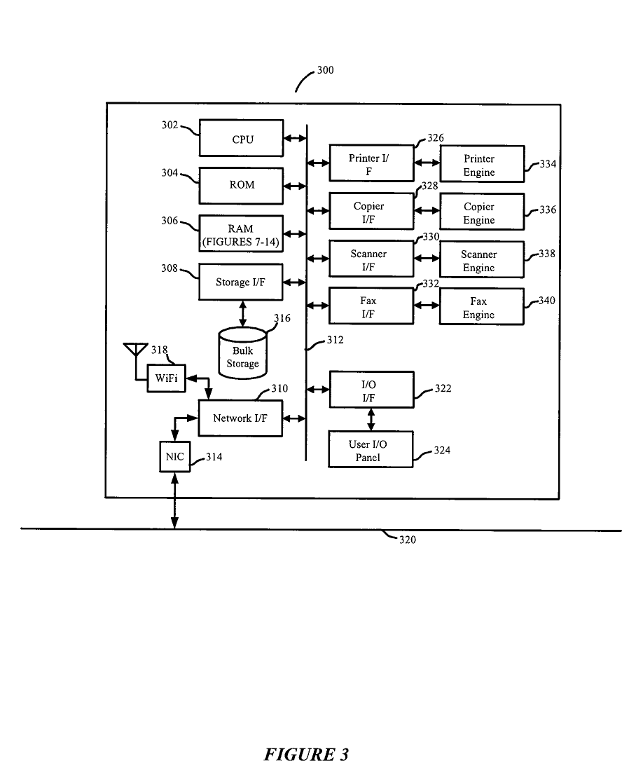

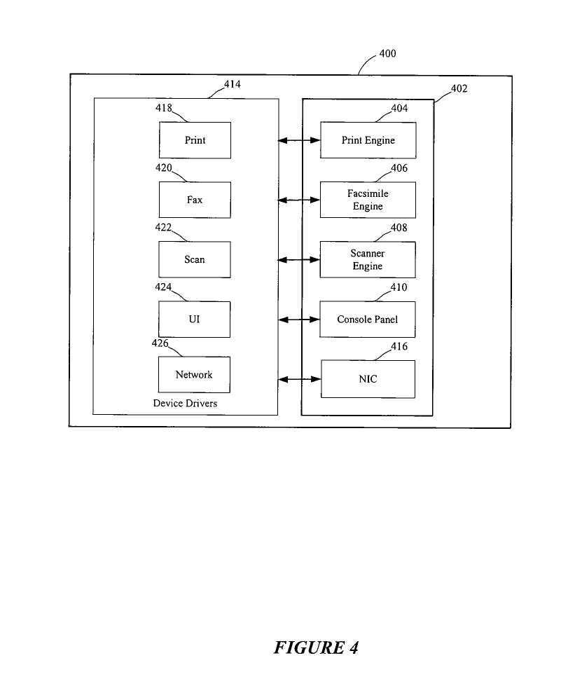

According to one embodiment of the subject application, the document rendering device 104 is suitably equipped to receive a plurality of portable storage media, including, without limitation, Firewire drive, USB drive, SD, MMC, XD, Compact Flash, Memory Stick, and the like. In the preferred embodiment of the subject application, the document rendering device 104 further includes an associated user interface 106, such as a touchscreen, LCD display, touch-panel, alpha-numeric keypad, or the like, via which an associated user is able to interact directly with the document rendering device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document rendering device 104 is communicatively coupled to the computer network 102 via a communications link 122. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document rendering device 104 will be better understood in conjunction with the block diagrams illustrated in FIGS. 3 and 4, explained in greater detail below.

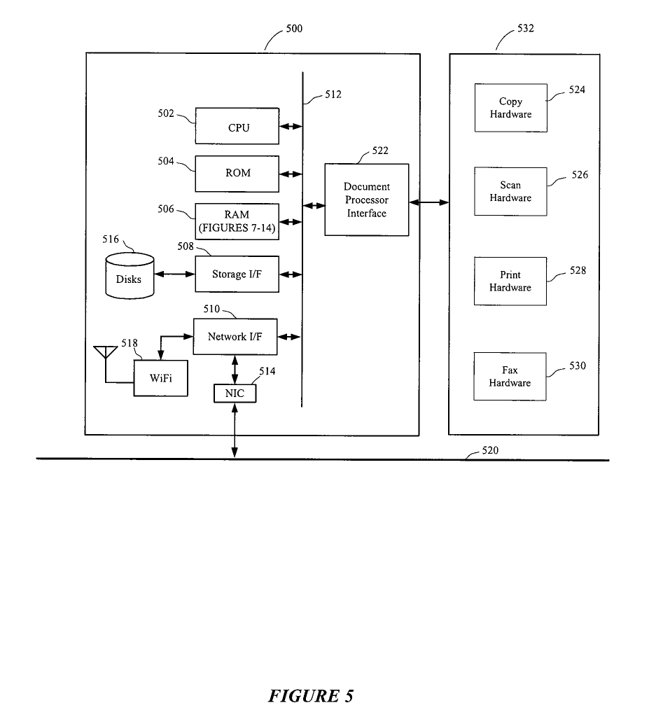

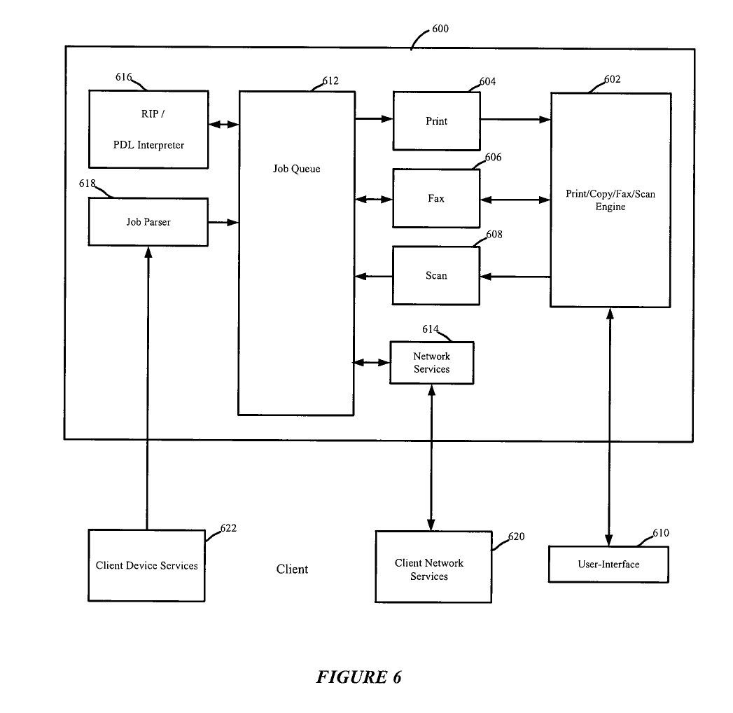

In accordance with one embodiment of the subject application, the document rendering device 104 incorporates a backend component, designated as the controller 108, suitably adapted to facilitate the operations of the document rendering device 104, as will be understood by those skilled in the art. Preferably, the controller 108 is embodied as hardware, software, or any suitable combination thereof, configured to control the operations of the associated document rendering device 104, facilitate the display of images via the user interface 106, direct the manipulation of electronic image data, and the like. For purposes of explanation, the controller 108 is used to refer to any myriad of components associated with the document rendering device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for greeting card template matching. The functioning of the controller 108 will better be understood in conjunction with the block diagrams illustrated in FIGS. 5 and 6, explained in greater detail below.

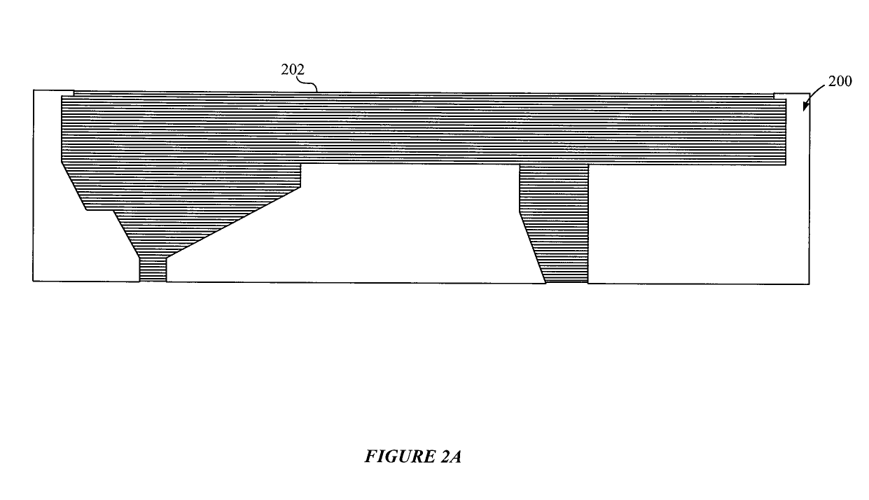

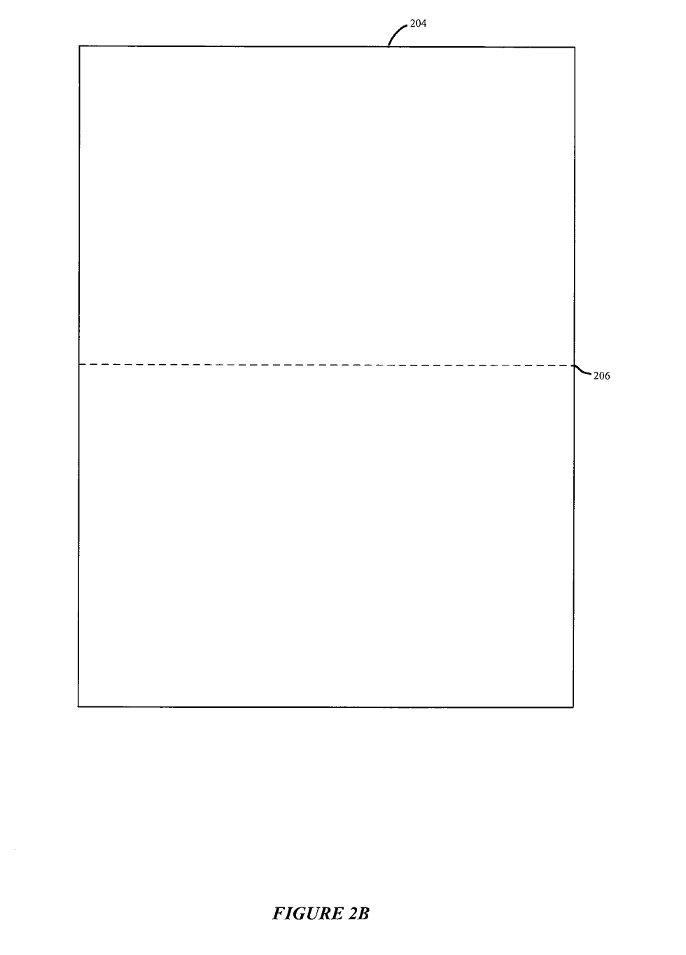

As depicted in FIG. 1, the document rendering device 104 further includes one or more media storage trays 110, suitably configured to stored output media for output by the document rendering device 110. The skilled artisan will appreciate that the media storage tray 110 is representative of any of a myriad of storage components associated with the document rendering device 104 capable of storing sheets of paper of varying sizes, sheets of transparencies, blank greeting cards, blank business cards, photographic paper, or any other output medium upon which documents or images are rendered. A close-up view of the media storage tray 110 is shown in FIG. 2A, discussed in greater detail below.

Communicatively coupled to the document rendering device 104 is a data storage device 112. In accordance with the one embodiment of the subject application, the data storage device 112 is any mass storage device known in the art including, for example and without limitation, magnetic storage drives, a hard disk drive, optical storage devices, flash memory devices, or any suitable combination thereof. In one embodiment, the data storage device 112 is suitably adapted to store scanned image data, modified image data, redacted data, user information, cellular telephone data, pre-set payment data, document data, image data, electronic database data, or the like. It will be appreciated by those skilled in the art that while illustrated in FIG. 1 as being a separate component of the system 100, the data storage device 112 is capable of being implemented as an internal storage component of the document rendering device 104, a component of the controller 108, or the like, such as, for example and without limitation, an internal hard disk drive, or the like. In accordance with one embodiment of the subject application, the data storage device 112 is capable of storing document processing instructions, usage data, user interface data, job control data, controller status data, component execution data, images, advertisements, user information, location information, output templates, mapping data, multimedia data files, fonts, and the like.

FIG. 1 also illustrates a kiosk 114 communicatively coupled to the document rendering device 104, and in effect, the computer network 102. It will be appreciated by those skilled in the art that the kiosk 114 is capable of being implemented as a separate component of the document rendering device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

Depicted in FIG. 1 is a user device 124, illustrated as a personal computer in data communication with the computer network 102 via a communications link 126. It will be appreciated by those skilled in the art that the user device 124 is shown in FIG. 1 as a computer workstation for illustration purposes only. As will be understood by those skilled in the art, the user device 124 is representative of any personal computing device known in the art including, for example and without limitation, a laptop computer, a workstation computer, a personal data assistant, a web-enabled cellular telephone, a smart phone, a proprietary network device, or other web-enabled electronic device. The communications link 126 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 124 is suitably adapted to receive redacted documents, status data, job data, user interface data, image data, monitor document processing jobs, employ thin-client interfaces, generate display data, generate output data, or the like, with respect to the document rendering device 104, or any other similar device coupled to the computer network 102.

Referring now to FIG. 2A, there is shown a representation diagram illustrating a media storage tray 200 associated with the document rendering device 104. As depicted in FIG. 2A, the storage tray 200 includes a plurality of output media 202, illustrated as greeting card blank output media in accordance with one embodiment of the subject application. It will be appreciated by those skilled in the art that the output media storage tray 200 of the subject application is capable of being configured to store any of a myriad of output media known in the art including, for example and without limitation, paper, poster board, transparencies, business card blanks, envelopes, or the like. The skilled artisan will further appreciate that the output media 202 shown in FIG. 2A is capable of implementation in a plurality of various sizes, e.g., letter, ledger, A4, legal, A5, or the like, dependent upon the type and size of media available to associated document rendering device 104. FIG. 2B illustrates a single greeting card blank sheet stock 204 corresponding to the output media 202 of FIG. 2A. As shown in FIG. 2B, the single greeting card blank stock 204 includes a creased portion 206 around which the greeting card is folded following output of a tangible document according to the subject application. It will be appreciated by those skilled in the art that the placement of the creased portion 206 of the greeting card blank stock 204 is for example purposes only, and other placements on a greeting card blank stock 204 so as to enable folding by an associated user, automated folding, or the like, as will be understood by those skilled in the art, are capable of implementation in accordance with the subject application.

Turning now to FIG. 3, illustrated is a representative architecture of a suitable device 300 on which operations of the subject system are completed. Included is a processor 302, suitably comprised of a central processor unit. However, it will be appreciated that the processor 302 may advantageously be composed of multiple processors working in concert with one another as will be appreciated by one of ordinary skill in the art. Also included is a non-volatile or read only memory 304 which is advantageously used for static or fixed data or instructions, such as BIOS functions, system functions, system configuration data, and other routines or data used for operation of the device 300.

Also included in the device 300 is random access memory 306, suitably formed of dynamic random access memory, static random access memory, or any other suitable, addressable memory system. Random access memory provides a storage area for data instructions associated with applications and data handling accomplished by the processor 302.

A storage interface 308 suitably provides a mechanism for volatile, bulk or long term storage of data associated with the device 300. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the device 300 to communicate to other devices. The network interface subsystem 310 suitably interfaces with one or more connections with external devices to the device 300. By way of example, illustrated is at least one network interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 314 is interconnected for data interchange via a physical network 320, suitably comprised of a local area network, wide area network, or a combination thereof.

Data communication between the processor 302, read only memory 304, random access memory 306, storage interface 308 and the network subsystem 310 is suitably accomplished via a bus data transfer mechanism, such as illustrated by bus 312.

Suitable executable instructions on the device 300 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 322 to a user input/output panel 324 as will be appreciated by one of ordinary skill in the art.

Also in data communication with bus 312 are interfaces to one or more document processing engines. In the illustrated embodiment, printer interface 326, copier interface 328, scanner interface 330, and facsimile interface 332 facilitate communication with printer engine 334, copier engine 336, scanner engine 338, and facsimile engine 340, respectively. It is to be appreciated that the device 300 suitably accomplishes one or more document processing functions. Systems accomplishing more than one document processing operation are commonly referred to as multifunction peripherals or multifunction devices.

Turning now to FIG. 4, illustrated is a suitable document rendering device for use in connection with the disclosed system. FIG. 4 illustrates suitable functionality of the hardware of FIG. 3 in connection with software and operating system functionality as will be appreciated by one of ordinary skill in the art. The document rendering device 400 suitably includes an engine 402 which facilitates one or more document processing operations.

The document processing engine 402 suitably includes a print engine 404, facsimile engine 406, scanner engine 408 and console panel 410. The print engine 404 allows for output of physical documents representative of an electronic document communicated to the processing device 400. The facsimile engine 406 suitably communicates to or from external facsimile devices via a device, such as a fax modem.

The scanner engine 408 suitably functions to receive hard copy documents and in turn image data corresponding thereto. A suitable user interface, such as the console panel 410, suitably allows for input of instructions and display of information to an associated user. It will be appreciated that the scanner engine 408 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 4, the document processing engine also comprises an interface 416 with a network via driver 426, suitably comprised of a network interface card. It will be appreciated that a network thoroughly accomplishes that interchange via any suitable physical and non-physical layer, such as wired, wireless, or optical data communication.

The document processing engine 402 is suitably in data communication with one or more device drivers 414, which device drivers allow for data interchange from the document processing engine 402 to one or more physical devices to accomplish the actual document processing operations. Such document processing operations include one or more of printing via driver 418, facsimile communication via driver 420, scanning via driver 422 and a user interface functions via driver 424. It will be appreciated that these various devices are integrated with one or more corresponding engines associated with the document processing engine 402. It is to be appreciated that any set or subset of document processing operations are contemplated herein. Document processors which include a plurality of available document processing options are referred to as multi-function peripherals.

Turning now to FIG. 5, illustrated is a representative architecture of a suitable backend component, i.e., the controller 500, shown in FIG. 1 as the controller 108, on which operations of the subject system 100 are completed. The skilled artisan will understand that the controller 500 is representative of any general computing device, known in the art, capable of facilitating the methodologies described herein. Included is a processor 502, suitably comprised of a central processor unit. However, it will be appreciated that processor 502 may advantageously be composed of multiple processors working in concert with one another as will be appreciated by one of ordinary skill in the art. Also included is a non-volatile or read only memory 504 which is advantageously used for static or fixed data or instructions, such as BIOS functions, system functions, system configuration data, and other routines or data used for operation of the controller 500.

Also included in the controller 500 is random access memory 506, suitably formed of dynamic random access memory, static random access memory, or any other suitable, addressable and writable memory system. Random access memory provides a storage area for data instructions associated with applications and data handling accomplished by processor 502.

A storage interface 508 suitably provides a mechanism for non-volatile, bulk or long term storage of data associated with the controller 500. The storage interface 508 suitably uses bulk storage, such as any suitable addressable or serial storage, such as a disk, optical, tape drive and the like as shown as 516, as well as any suitable storage medium as will be appreciated by one of ordinary skill in the art.

A network interface subsystem 510 suitably routes input and output from an associated network allowing the controller 500 to communicate to other devices. The network interface subsystem 510 suitably interfaces with one or more connections with external devices to the device 500. By way of example, illustrated is at least one network interface card 514 for data communication with fixed or wired networks, such as Ethernet, token ring, and the like, and a wireless interface 518, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 520, suitably comprised of a local area network, wide area network, or a combination thereof.

Data communication between the processor 502, read only memory 504, random access memory 506, storage interface 508 and the network interface subsystem 510 is suitably accomplished via a bus data transfer mechanism, such as illustrated by bus 512.

Also in data communication with bus the 512 is a document processor interface 522. The document processor interface 522 suitably provides connection with hardware 532 to perform one or more document processing operations. Such operations include copying accomplished via copy hardware 524, scanning accomplished via scan hardware 526, printing accomplished via print hardware 528, and facsimile communication accomplished via facsimile hardware 530. It is to be appreciated that the controller 500 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document rendering device 104, which includes the controller 600 of FIG. 6, (shown in FIG. 1 as the controller 108) as an intelligent subsystem associated with a document rendering device. In the illustration of FIG. 6, controller function 600 in the preferred embodiment, includes a document processing engine 602. A suitable controller functionality is that incorporated into the Toshiba e-Studio system in the preferred embodiment. FIG. 6 illustrates suitable functionality of the hardware of FIG. 5 in connection with software and operating system functionality as will be appreciated by one of ordinary skill in the art.

In the preferred embodiment, the engine 602 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that are subset of the document processing operations listed above.

The engine 602 is suitably interfaced to a user interface panel 610, which panel allows for a user or administrator to access functionality controlled by the engine 602. Access is suitably enabled via an interface local to the controller, or remotely via a remote thin or thick client.

The engine 602 is in data communication with the print function 604, facsimile function 606, and scan function 608. These functions facilitate the actual operation of printing, facsimile transmission and reception, and document scanning for use in securing document images for copying or generating electronic versions.

A job queue 612 is suitably in data communication with the print function 604, facsimile function 606, and scan function 608. It will be appreciated that various image forms, such as bit map, page description language or vector format, and the like, are suitably relayed from the scan function 608 for subsequent handling via the job queue 612.

The job queue 612 is also in data communication with network services 614. In a preferred embodiment, job control, status data, or electronic document data is exchanged between the job queue 612 and the network services 614. Thus, suitable interface is provided for network based access to the controller function 600 via client side network services 620, which is any suitable thin or thick client. In the preferred embodiment, the web services access is suitably accomplished via a hypertext transfer protocol, file transfer protocol, uniform data diagram protocol, or any other suitable exchange mechanism. The network services 614 also advantageously supplies data interchange with client side services 620 for communication via FTP, electronic mail, TELNET, or the like. Thus, the controller function 600 facilitates output or receipt of electronic document and user information via various network access mechanisms.

The job queue 612 is also advantageously placed in data communication with an image processor 616. The image processor 316 is suitably a raster image process, page description language interpreter or any suitable mechanism for interchange of an electronic document to a format better suited for interchange with device functions such as print 604, facsimile 606 or scan 608.

Finally, the job queue 612 is in data communication with a parser 618, which parser suitably functions to receive print job language files from an external device, such as client device services 622. The client device services 622 suitably include printing, facsimile transmission, or other suitable input of an electronic document for which handling by the controller function 600 is advantageous. The parser 618 functions to interpret a received electronic document file and relay it to the job queue 612 for handling in connection with the afore-described functionality and components.

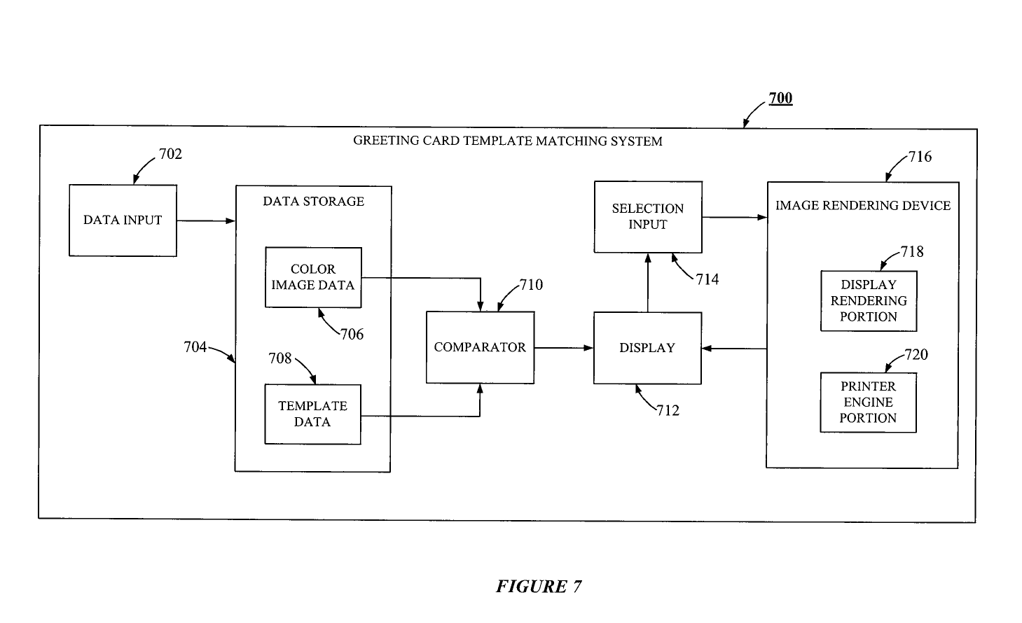

Turning now to FIG. 7, illustrated is a block diagram of a system 700 for greeting card template matching in accordance with one embodiment of the subject application. The greeting card template matching system 700 includes a data input 702, in communication with a data storage 704 via which data input 702 color image data 706 is received from an associated user and stored in the data storage 704. Preferably, the color image data 706 comprises a plurality of color encoded pixels, wherein each pixel is defined in accordance with components of a multidimensional color space. The data storage 704 also stores template data 708 corresponding to a plurality of color greeting card templates. In accordance with one embodiment of the subject application, each color greeting card template has template color data corresponding to colorization of the associated template.

The system 700 further comprises a comparator 710 operable between the pixels of the color image data 706 relative to the colorization of each of the stored templates of the template data 708. A display 712 is then implemented in the system 700 so as to output indicia corresponding to greeting card templates identified by the comparator 710 in association with the color image data 706. The system 700 also includes a selection input 714 which receives selection data corresponding to at least one of a subset of the greeting card templates represented by the indicia on the display 712. The system further includes an image rendering device 716 that is operable on the color image data 706 and each greeting card template specified by the selection data received via the selection input 714. According to one embodiment of the subject application, the image rendering device 716 employs a display rendering portion 718 and a printer engine portion 720. The display rendering portion 718 and the printer engine portion 720 are suitably configured to render both a composite image of the color image data and each greeting card template specified by the selection data on the display 712 and on a tangible print medium (not shown).

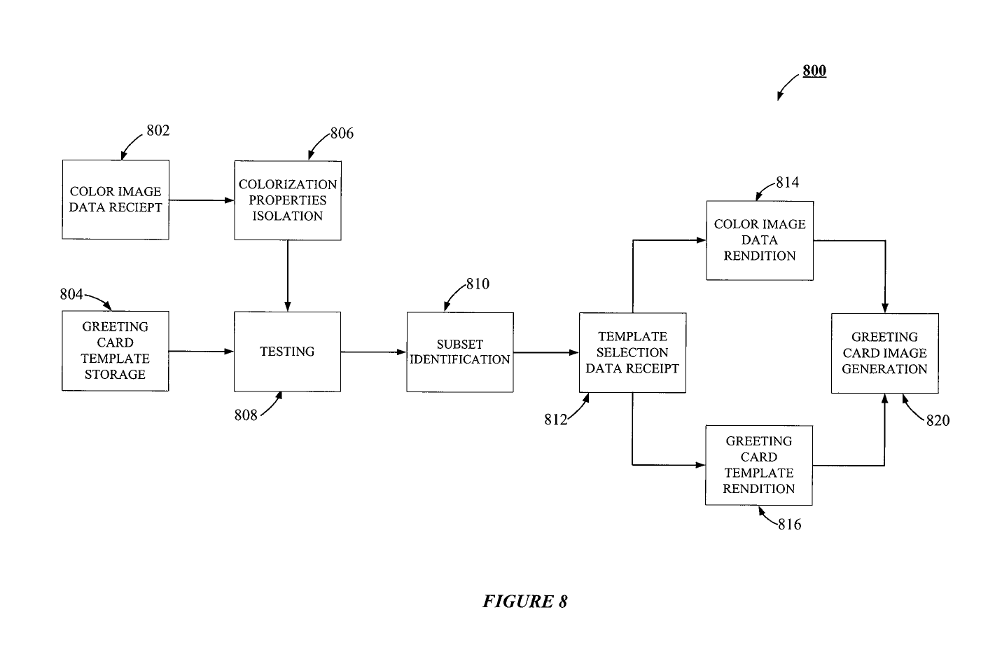

Referring now to FIG. 8, there is shown a functional diagram 800 illustrating a greeting card template matching system in accordance with one embodiment of the subject application. Color image data receipt 802 first occurs corresponding to the receipt of color image data from an associated user. Greeting card template data storage 804 also is performed on a plurality of greeting card templates, each of which includes colorization data. Colorization properties isolation 806 is then performed on received color image data 802 so as to isolate the colorization properties associated therewith. Testing 808 is then performed on the isolated colorization properties resulting from the isolation 806 of received color image data 802 and the stored greeting card templates 804.

Subset identification 810 is then performed of a subset of greeting cards from the greeting card storage 804 in accordance with the output from the testing 808. Template selection data receipt 812 then occurs corresponding to the receipt of a selection from an associated user of at least one of the greeting cards from the identified subset 810. Color image data rendition 814 and greeting card template rendition 816 are then performed in accordance with the template selection data received 812. Thereafter, greeting card image generation 820 then occurs in accordance with the color image data rendition 814 and greeting card template rendition 816.

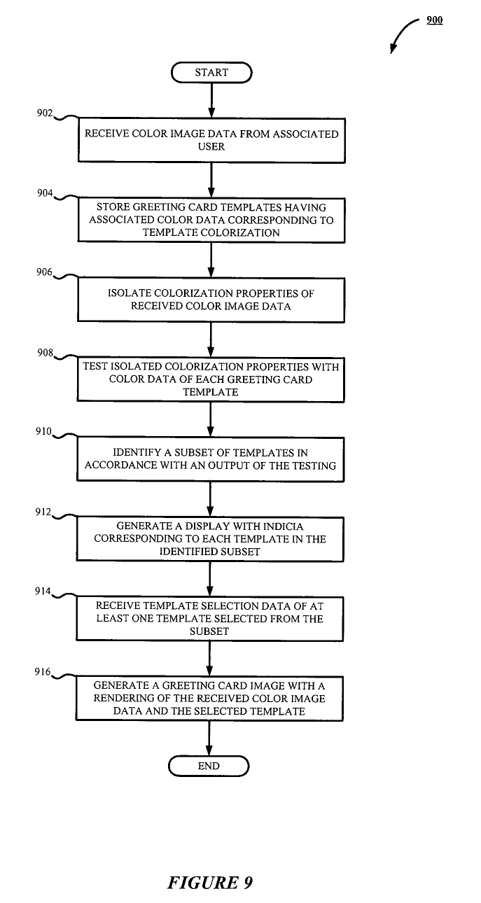

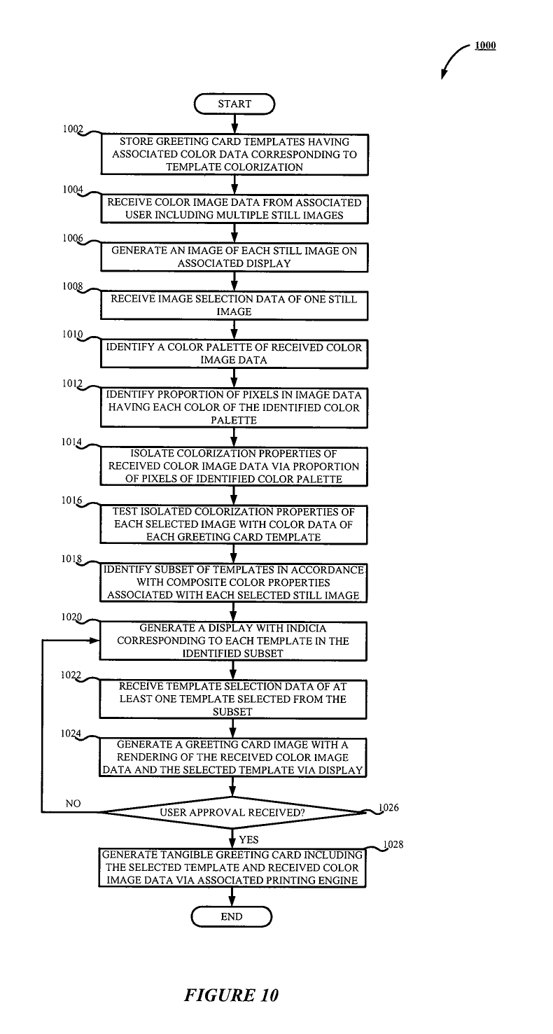

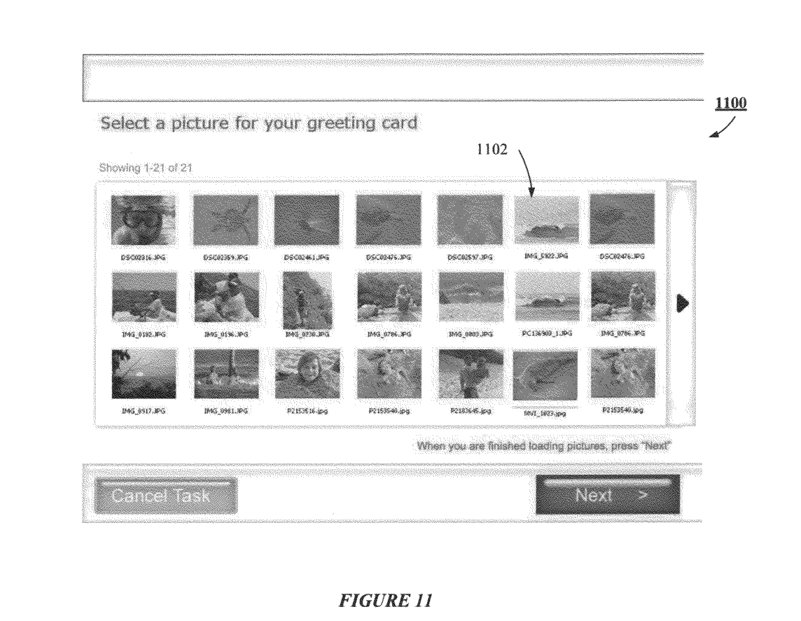

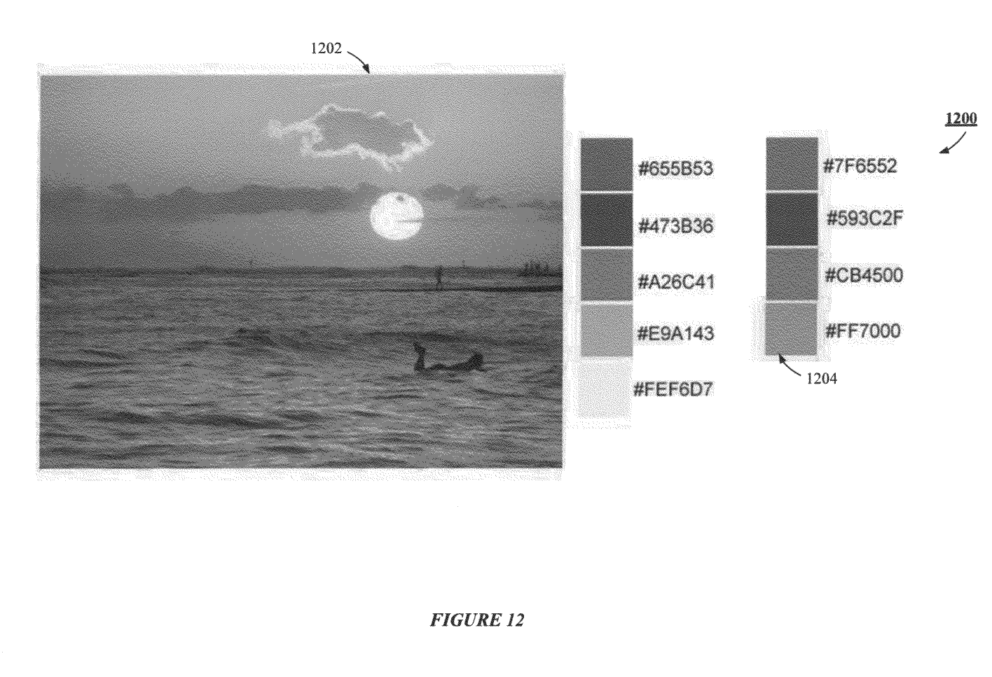

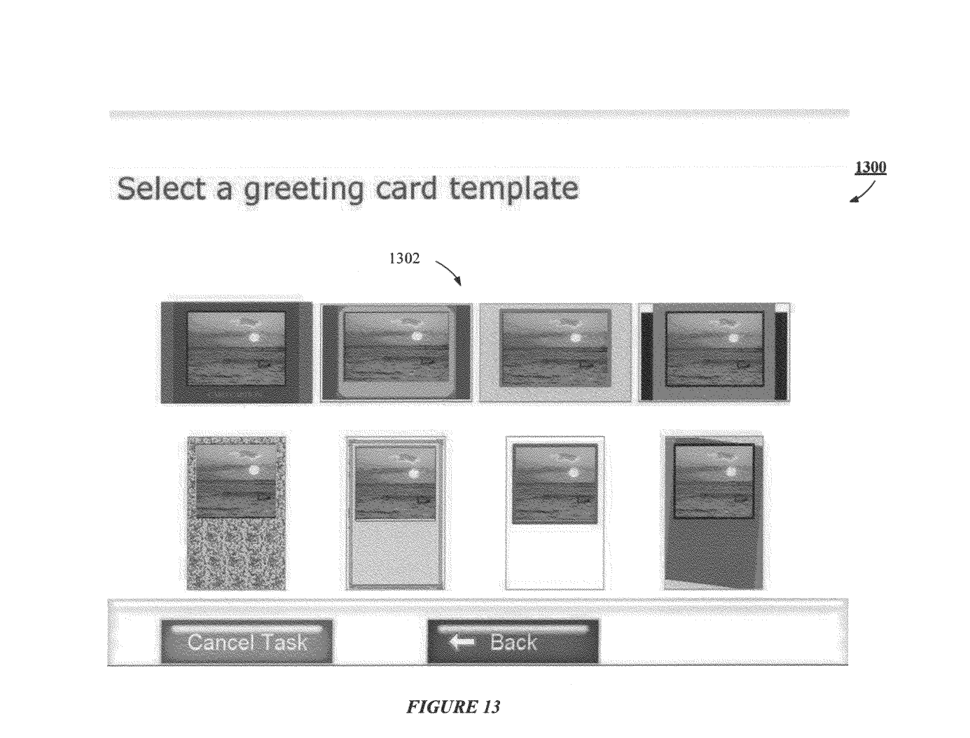

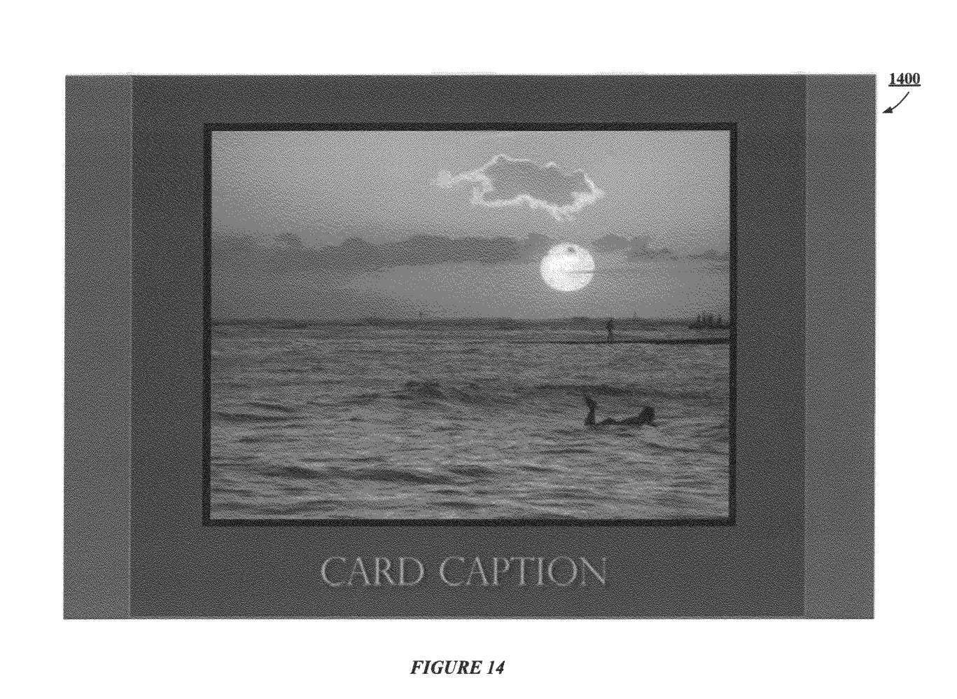

The skilled artisan will appreciate that the subject system 100 and components described above with respect to FIG. 1, FIG. 2A, FIG. 2B, FIG. 3, FIG. 4, FIG. 5, FIG. 6, FIG. 7, and FIG. 8 will be better understood in conjunction with the methodology described hereinafter with respect to FIG. 9 and FIG. 10, as well as the example implementations illustrated in FIG. 11, FIG. 12, FIG. 13, and FIG. 14. Turning now to FIG. 9, there is shown a flowchart 900 illustrating a method for greeting card template matching in accordance with one embodiment of the subject application. Beginning at step 902, color image data is received by the document rendering device 104 from an associated user. It will be appreciated by those skilled in the art that the color image data is capable of being received from a communication from the user device 124, from a portable storage device, via electronic communication from or the like.

A plurality of greeting card templates, each greeting card template having associated color data corresponding to a colorization of the template, is then stored at step 904. In accordance with one embodiment of the subject application, the color greeting card templates are stored in data storage device 112 associated with the document rendering device 104. At step 906, colorization properties of the received color image data are isolated by the controller 108 or other suitable component associated with the document rendering device 104, the user device 104, or the like. The controller 108 or other suitable component associated with the document rendering device 104 then tests isolated colorization properties of the received color image data relative to color data corresponding to each of the plurality of greeting card templates at step 908.

At step 910, a subset of the plurality of greeting card templates is then identified by the lo controller 108 or other suitable component associated with the document rendering device 104 based upon the output of the testing performed at step 908. A display is then generated at step 912 with indicia corresponding to each of the color greeting card templates in the identified subset. It will be appreciated by those skilled in the art that the display of indicia is capable of being undertaken via the display 116 associated with the kiosk 114, the user interface 106 associated with the document rendering device 104, or the like. Template selection data is then received at step 914 corresponding to at least one greeting card template selected from the subset thereof. Stated another way, the user selects a desired greeting card template from among those displayed via the user interface 106, the kiosk 114, or the like. A color greeting card image is then generated by the controller 108 or other suitable component associated with the document rendering device 104 with a rendering of the received color image data and the selected color greeting card template at step 916.

Referring now to FIG. 10, there is shown a flowchart 1000 illustrating a method for greeting card template matching in accordance with one embodiment of the subject application. The methodology of FIG. 10 begins at step 1002, whereupon a plurality of color greeting card templates are stored on the data storage device 112 associated with the document rendering device 104. Preferably, each of the color greeting card templates has associated color data that corresponds to its colorization. The document rendering device 104 then receives color image data from an associated user including a plurality of still images at step 1004. That is, the document rendering device 104 receives still images from the associated user via a portable storage device, a digital camera, an electronic communication, a network storage, or the like. At step 1006, an image of each still image is generated on a display (display 116 of the kiosk 114, or the user interface 106) associated with the document rendering device 104. FIG. 11 illustrates a template screen 110 depicting the display of a plurality of still images 1102 for selection thereof by the user.

At step 1008, the controller 108 or other suitable component associated with the document rendering device 104 then receives image selection data from the user via the user interface 106 or kiosk 114 corresponding to a desired still image from among the images 1102 displayed at step 1006. The controller 108 or other suitable component associated with the document rendering device 104 the identifies a color palette associated with the selected still image selected by the associated user at step 1010. FIG. 12 illustrates an example 1200 of a selected still image 1202 and an associated identified palette of colors 1204 associated with the selected image 1202. A proportion of pixels in the selected still image 1202 having each color of the identified color palette 1204 are then identified by the controller 108 or other suitable component associated with the document rendering device 104 at step 1012. The skilled artisan will appreciate that such identification enables the controller 108 or other suitable component associated with the document rendering device 104 to ascertain the most common color or colors contained in the selected still image 1202.

Colorization properties of the selected still image 1202, i.e. color image data, are then isolated at step 1014 via the proportion of pixels of the identified color palette by the controller 108 or other suitable component associated with the document rendering device 104. At step 1016, the isolated colorization properties of the selected still image 1202 are tested relative to colorization data of the color greeting card templates in the data storage device 112. That is, the isolated color properties of the selected image 1202 are tested against the colorization data associated with each color greeting card template stored in the data storage device 112. The controller 108 or other suitable component associated with the document rendering device 104 then identifies a subset of color greeting card templates in accordance with composite color properties associated with the selected still image 1202 at step 1018. In accordance with one embodiment of the subject application, the color greeting card templates in the subset are identified based upon respective colors corresponding to the colors identified in the selected still image 1202.

At step 1020, a display is generated with indicia corresponding to each template in the identified subset of templates, e.g. a graphical depiction of the subset is generated via the user interface 106, the display 116 of the kiosk 114, or the like. FIG. 13 illustrates a screen template 1300 depicting the display of a subset 1302 of greeting card templates corresponding to the color palette of the selected still image 1202. Template selection data is then received via the user interface 106, the kiosk 114, or the like corresponding to a color greeting card template desired by the associated user at step 1022. The skilled artisan will appreciate that such selection data is capable of being received from the associated user via input from the user via the user interface 106 or display 116.

Following receipt of a selected greeting card template from the user, flow proceeds to step 1024, whereupon the controller 108 or other suitable component associated with the document rendering device 104 facilitates the generation of a greeting card image on the user interface 106 or display 116 that incorporates a rendering of the selected still image and the selected template. FIG. 14 illustrates such a display 1400 of a greeting card that embodies both the selected template and the selected still image. A determination is then made at step 1026 whether or not the user approves of the greeting card displayed via the user interface 106 or display 116. When the user rejects such a greeting card, operations return to step 1020, whereupon the user interface 106 or display 116 returns to displaying the subset 1302 of color greeting card templates that correspond to the color palette of the selected still image 1202. When the user approves of the greeting card displayed on the user interface 106 or display 116, flow proceeds to step 1028. At step 1028, a printing engine associated with the document rendering device 104 generates a tangible greeting card including the selected color greeting card template and the received color image data, i.e. the selected still image. In accordance with one embodiment of the subject application, the document rendering device 104 calculates a suitable charge associated with the production of the tangible greeting card, which the associated user pays, e.g. credit card, prepaid account, cash, coupon, or the like, prior to the production of the customized greeting card.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A greeting card template matching system comprising:
a data input;
a data storage storing color image data received via the data input, the color image data comprised of a plurality of color encoded pixels, each pixel defined in accordance with components of a multidimensional color space;
the data storage further storing template data corresponding to each of a plurality of color greeting card templates having associated therewith template color data corresponding to a colorization thereof;
a comparator operable between pixels of the color image data relative to colorization associated with each of the plurality of greeting card templates;
a display outputting indicia corresponding to greeting card templates identified by the comparator;
a selection input for selection data corresponding to at least one of a subset of the greeting card templates represented by indicia on the display; and
an image rendering device operable on the color image data and each greeting card template specified by selection data.

2. The system of claim 1 wherein the rendering device includes a display rendering portion and a printer engine portion so as to render both a composite image of the color image data and each greeting card template specified by the selection data on the display and on a tangible print medium.

3. The system of claim 2 wherein the comparator compares relative numbers of pixel colors in the received color image data with template color data.

4. The system of claim 3 wherein the comparator further determines at least a first color value of the color image data having a greatest number of pixels associated therewith.

5. The system of claim 4 wherein the comparator further determines at least a second color value of the color image data having a second greatest number of pixels associated therewith.

6. The system of claim 2 wherein the display includes composite renderings of the image data with each of the subset of greeting card templates.

7. A greeting card template matching method comprising the steps of:
receiving color image data from an associated user;
storing a plurality of greeting card templates, each greeting card template having associated therewith color data corresponding to a colorization thereof;
isolating colorization properties of received color image data;
testing isolated colorization properties of received color image data relative to color data corresponding to each of the plurality of greeting card templates;
identifying a subset of the plurality of greeting card templates in accordance with an output of the testing;
generating a display including indicia corresponding to each of the subset of greeting card templates;
receiving template selection data corresponding to at least one greeting card template selected from the subset thereof; and
generating a greeting card image inclusive of a rendering of the received color image data and the at least one greeting card template.

8. The method of claim 7 wherein the greeting card image is generated on the display, and a tangible greeting card inclusive of the at least one greeting card template and received color image data is generated from an associated printing engine.

9. The method of claim 7 wherein received color image data includes a plurality of still images, and wherein the method further includes,
generating an image corresponding to each of the still images on the display;
receiving image selection data corresponding to at least one still image selected from still images on the display; and
testing isolated colorization properties of each selected image relative to color data corresponding to each of the plurality of greeting card templates.

10. The method of claim 9 wherein the step of identifying a subset of the plurality of greeting card templates includes identifying the subset in accordance with a composite color properties associated with each of the selected still images.

11. The method of claim 7 wherein the isolating step includes identifying a color palette of received color image data.

12. The method of claim 11 wherein the isolating step includes identifying a proportion of pixels in the image data having each color of the identified color palette.

13. A greeting card template matching system comprising:
means adapted for receiving color image data from an associated user;
storage means adapted for storing a plurality of greeting card templates, each greeting card template having associated therewith color data corresponding to a colorization thereof;
isolating means adapted for isolating colorization properties of received color image data;
testing means adapted for testing isolated colorization properties of received color image data relative to color data corresponding to each of the plurality of greeting card templates;
identifying means adapted for identifying a subset of the plurality of greeting card templates in accordance with an output of the testing means;
means adapted for generating a display including indicia corresponding to each of the subset of greeting card templates;
means adapted for receiving template selection data corresponding to at least one greeting card template selected from the subset thereof; and
means adapted for generating a greeting card image inclusive of a rendering of the received color image data and the at least one greeting card template.

14. The system of claim 13 wherein the greeting card image is generated on the display, and wherein the system further includes means adapted for generating a tangible greeting card inclusive of the at least one greeting card template and received color image data from an associated printing engine.

15. The system of claim 13 wherein received color image data includes a plurality of still images, and wherein the system further includes,
means adapted for generating an image corresponding to each of the still images on the display;
means adapted for receiving image selection data corresponding to at least one still image selected from still images on the display; and
wherein the image data for each selected image is communicated to the testing means.

16. The system of claim 15 wherein the identifying means includes means adapted for identifying the subset in accordance with a composite color properties associated with each of the selected still images.

17. The system of claim 13 wherein the isolating means includes means adapted for identifying a color palette of received color image data.

18. The system of claim 17 wherein the isolating means further includes means adapted for identifying a proportion of pixels in the image data having each color of the identified color palette.
